(19) United States
(12) Patent Application Publication
(10) Pub. No.: US 2008/0292983 A1
(43) Pub. Date: Nov. 27, 2008

(54) Magnetic One-Component Toner for Development of Electrostatic Latent Image and Image Forming Method

(75) Inventors: Hiroshi Mizuhata, Osaka-shi (JP); Yukinori Nakayama, Osaka-shi (JP); Kousuke Satou, Osaka-shi (JP); Akira Tanaka, Osaka-shi (JP); Kouzuo Teramoto, Osaka-shi (JP)

Correspondence Address: CLARK & BRODY, 1090 VERMONT AVENUE, NW, SUITE 250, WASHINGTON, DC, 20005, US

(73) Assignee: KYOCERA MITA CORPORATION, Osaka-shi (JP)

(21) Appl. No.: 11/659,850

(22) PCT Filed: Aug. 11, 2005
(86) PCT No.: PCT/JP05/14729

§ 371 Date: May 19, 2008

(30) Foreign Application Priority Data
Aug. 12, 2004 (JP) 2004-235361
Aug. 30, 2004 (JP) 2004-250500
Sep. 13, 2004 (JP) 2004-265411

(51) Int. Cl. G03G 9/083; G03G 21/00

(52) U.S. Cl. 430/108.6; 430/119.82

(57) ABSTRACT

Disclosed is a magnetic one-component toner for development of an electrostatic latent image used in a magnetic one-component jumping development system in which a photoconductor is an a-Si photoconductor having a thickness of 30 μm or less and Rz of a developer carrier is from 2.0 to 6.0 μm. A cleaning means for removing the toner from the surface of the photoconductor is a cleaning blade. Titanium oxide, as an external additive, is added to the toner. The titanium oxide has a liberation rate within a range from 10 to 22% and contains a low resistance titanium oxide having a volume resistivity within a range from 10⁰ to 10⁷Ω·cm and a high resistance titanium oxide having a volume resistivity within a range from 10⁸ to 10¹³Ω·cm, a mass ratio of the low resistance titanium oxide to the high resistance titanium oxide within a range from 1.3:1 to 4:1.

### TECHNICAL FIELD

The present invention relates to a dry magnetic one-component toner which is used to develop electrostatic charge images (electrostatic latent images) formed in an electrophotographic method, an electrostatic recording method, and an electrostatic printing method.

### BACKGROUND ART

In an electrophotographic method and an electrostatic recording method, a latent image support made of a photoconductive photoreceptor or a dielectric is charged by corona charging and exposed by laser or LED to form electrostatic latent images, which are visualized using a developer such as toner, or electrostatic latent images are visualized by a reversal development to obtain high quality images. As a toner to be applied to these developing methods, it is possible to use toner particles having an average particle size of 5 to 15 μm which are obtained by mixing a thermoplastic resin (binder resin) as a binder with a coloring agent, a dye or pigment as a charge control agent, and a wax as a releasant or a magnetic material, followed by kneading, ground and further classification of the mixture. For the purpose of imparting fluidity to the toner, charge-controlling the toner or improving cleaning properties, inorganic fine powders and inorganic metal fine powders of silica and titanium oxide are externally added.

As a dry developing method used in various electrostatic printing systems which are put into practical use at present, for example, there are known a two-component developing system which uses a carrier such as toner and iron powders, and a magnetic one-component developing system which uses no carrier and contains a magnetic material in the toner.

Also various methods for developing electrostatic latent images have been developed and put into practical use. For example, there have been known various developing methods such as magnetic brush method described in Patent Document 1, and a cascade developing method, a powder cloud method and a fur brush developing method described in Patent Document 2. Among these methods, a magnetic brush method and a cascade method, which use a two-component developer composed mainly of a toner and a carrier, are widely put into practical used. These methods using the two-component developer can provide comparatively stable and good quality images at the initial stage, but have such a problem that, when used for a long period, deterioration of the carrier, that is, a spent phenomenon occurs and therefore chargeability of the carrier deteriorates and good images can not be obtained for a long period, and also have such a common drawback that it is hard to fixedly maintain a mixing ratio of the toner to the carrier, resulting in lack of long-term durability.

To avoid such a drawback, various developing methods using a one-component developer composed mainly of a toner are proposed. Among these developing methods, a magnetic one-component developing system which employs a magnetic toner is well known and is employed.

As a developing method using a magnetic one-component toner, a developing method using a conductive magnetic toner which is disclosed in Patent Document 3 is known. According to this method, a conductive magnetic toner is kept on a cylindrical conductive developer carrier having magnetism inside and is brought into contact with electrostatic latent images, thereby developing the images. In this case, in the developing portion, a conducting path is formed between the surface of a latent image support and the surface of a sleeve by toner particles and charge is applied from the sleeve to the toner particles via the conducting path and the toner particles are adhered to the image area by a coulomb force between the electrostatic latent images and the image area, and then developed. Since the toner is conductive, this method has such a problem that it is difficult to electrostatically transfer the toner images on a latent image support printing medium (for example, plain paper) utilizing an electric field, a problem that it is difficult to obtain high image quality because of a fault phenomenon caused by a conductive toner in the respective steps, and a problem such as electrical leak breakdown to the latent image support.

Also a system using an insulating toner is proposed in Patent Document 4. This system is referred to as a magnetic one-component jumping development system in which a developer carrier is arranged facing to a latent image support and this developer carrier comprises a developing sleeve including a magnet roller installed therein. The toner is conveyed by rotation of the developing sleeve and is passed through the space between the developing sleeve and a magnetic blade to form a toner thin layer, and also electrostatic latent images on the surface of the latent image support are developed by the charged toner. According to this system, excellent images are obtained because there is a merit that surface fog is prevented.

As described above, a problem such as lack of long-term durability in the two-component developer can be solved by using the magnetic one-component developing method. Feature of a processor used in the developing method is that it can have a very small and simple constitution.

While present problems were described above with priority given to the toner, background arts including an image forming apparatus will now be described. At present, almost all of printers are equipped with an organic photoconductor (OPC) as a photoconductor. As durability of a machine is improved, printers using an amorphous silicone photoconductor (a-Si photoconductor) is also used. Lifetime of OPC is about 50,000 sheets, whereas, lifetime of the a-Si photoconductor is 500,000 sheets or more and the printer has very high durability. This is because that the thickness loss rate of the a-Si photoconductor is 1/100 or less of the thickness loss rate of OPC.

For example, Patent Document 5 proposes an image forming method in which a cleaning blade is used as a cleaning means of a photoconductor and the member is made of an urethane rubber, and also a magnetic toner is employed as a developer. It is considered that this method can achieve satisfactory cleaning by a simple cleaning mechanism and form clear images, and neither causes image defects such as fog and image unevenness nor deterioration of image density. However, according to this method, durability is unsatisfactory. Since the photoconductor is an OPC drum, fatal defects are formed on images. That is, even if considerations are made with respect to an external additive, the surface of a soft OPC drum is likely to be scratched, and therefore there arise problems that the toner is embedded onto the surface of the scratched photoconductor and therefore filming occurs and the toner passes through the cleaning blade. This is apparent from the fact that this image forming apparatus can achieve only about 150,000 sheets in the evaluation of durability.

In case of using the a-Si photoconductor, there is a problem that the a-Si photoconductor requires a long film forming time and productivity deteriorates and therefore the cost is higher than that of OPC. Although a conventional a-Si photoconductor has a thickness of 30 to 60 μm, an apparatus using a thin film silicone drum having a thickness of 30 μm or less has recently been put on the market so as to obtain high resolution by further decreasing the thickness, in addition to a problem on cost.

The cleaning means used in an image forming apparatus using an a-Si photoconductor includes a brush type cleaning means and a blade type cleaning means, but a blade type cleaning means is often used because of compactification of the product and simplification of a mechanism. Therefore, a system using a-Si photoconductor drum made of a thin film and a cleaning blade in combination is widely used in view of high durability, high resolution and compactification of the product.

However, in an image forming apparatus in which a-Si photoconductor made of a thin film is used and also a blade type cleaning means is used, there arises a problem such as abnormal images formed by dielectric breakdown of a photoconductor film in a conventional magnetic one-component toner. This problem becomes more severe when the a-Si photoconductor is easily damaged by dielectric breakdown as compared with OPC and also a thin film is used. Dielectric breakdown occurs at a blade ridgeline (in the vicinity of a tip portion) at which a drum is cleaned and, when the accumulated toner (continuous retention of the same toner, external additive) is excessively charged by friction with the blade (overcharge) and then discharging is conducted at a time when the charge amount exceeds certain upper limit. It is considered that dielectric breakdown of the photoconductor is caused by point discharge (discharge in the ultramicro area) toward the photoconductor at that time. When the dielectric breakdown occurs, breakage of a photosensitive layer of the photoconductor as an unrepairable defect occurs and black dots remarkably appear on an image.

On the other hand, in the markets of printing machines and printers which employ an electrophotographic method and an electrostatic printing method, speedup of printing, size reduction of machines and elongation of machine lifetime have remarkably developed, recently. In order to realize an improvement in image characteristics and durability corresponding to a printing speed with the speedup on printing, a toner having stable charging characteristics is indispensable and there is also required a toner which does not exert an adverse influence on the step of the respective processes, particularly a toner capable of decreasing an influence on a photoconductor drum which exerts an influence on image quality.

However, a system comprising a conventional a-Si photoconductor or OPC, an electrostatic developer and a magnetic toner cannot satisfy high resolution, high image quality and high durability, as described above. That is, there has never been obtained a system capable of satisfying requirements of the market, comprising a toner which can stably maintain charging characteristics for a long period and does not exert an influence on the step of the respective processes, and a photoconductor which can realize long-term durability and high resolution.

For example, Patent Document 6 discloses an example of a method in which a latent image support made of a laminated type a-Si and a magnetic one-component toner. According to this method, cleaning properties can be improved and satisfactory images can be stably formed many times without forming image defects caused by poor cleaning. However, according to this method, it is intended to enable a magnetic toner to serve as a spacer by adhesion (external addition) of organic fine particles and the organic fine particles have very high chargeability and therefore immediately causes chargeup through frictional electrification. Consequently, in the developing step, the amount of the toner present in proper charging area decreases, thereby causing image defects such as deterioration of image density, fog and image unevenness, and therefore it is impossible to provide stable and beautiful images for a long period. In the important photoconductor cleaning portion, the material of the cleaning blade is not clearly described. When an elastic blade of a simple (general) mechanism is used, unescapable charge is accumulated to the toner while bringing into contacted with the toner to cause frictional electrification, and thus increasing a possibility of generating overdischarge (point discharge, spark discharge) to the photoconductor thereby to break the surface of the photoconductor drum (charge generating layer, charge transporting layer) and to form unrepairable defects (only poor images are obtained).

Patent Document 7 describes a toner in which a liberated magnetic powder is present so as to prevent dielectric breakdown of the photoconductor. This document describes that leak can be prevented by the liberated magnetic powder, but there is a feat that the liberated magnetic powder adheres onto the developing sleeve or the photoconductor. It is well known that, even a small amount of the magnetic powder adheres, a mass of the magnetic powder grows in the presence of magnetic powder adheres as a nucleus thereby to cause fatal image defects. This document describes that dielectric breakdown can be prevented by an improved photoconductor as compared with the toner.

Patent Document 8 describes that dielectric breakdown of the photoconductor can be suppressed by giving the thickness of the photoconductor suitably. However, there is not described a special definition with respect to the toner and a counter plan for the toner, which is considered as a cause of dielectric breakdown, is not considered. In future, when a toner having different characteristics is used, there also arises a fear of dielectric breakdown of the photoconductor.

Patent Document 9 proposes a two-component developer comprising a toner containing fine particles including silicon atoms as a main component added therein, in which a liberation rate of silicon atoms and that of titanium atoms are defined. However, dielectric breakdown of the photoconductor is not described and an improvement in image characteristics due to prevention of chargeup is mainly described.

Patent Document 10 describes a non-magnetic color toner produced by a polymerization method in which a number liberation rate of titanium oxide to be externally added to the toner is defined. Patent Document 11 describes a non-magnetic toner used in a two-component developer in which a number liberation rate of titanium oxide to be externally added to the toner is defined. It is described that these toners can provide high quality images for a long period. However, Patent Document 10 and Patent Document 11 do not describe dielectric breakdown of the photoconductor which is a problem peculiar to an image forming method using an a-Si photoconductor.

Patent Document 12 describes that charging characteristics of the toner can be improved by defining a volume resistivity value of titanium oxide to be externally added to the toner, but does not describe dielectric breakdown of the photoconductor at all.

Conventional inorganic metal fine powders have very high hydrophilicity because of hydroxyl groups which are present on the surface. Therefore, when the inorganic metal fine powders are added to the toner, fluidity and charging rise characteristics of the toner vary by an influence of humidity and therefore exerts an adverse influence on printing durability and image density.

In order to prevent an influence of environmental conditions such as humidity, the surface of inorganic metal fine powders is treated with a hydrophobizing agent, or polar groups are introduced. For example, Patent Document 13 proposes a technique in which metal oxide treated with aminosilane is used so as to introduce polar groups. Patent Document 14 proposes that a titanium compound treated with a silane coupling agent is used. Furthermore, Patent Document 15 proposes an electrostatic latent image developer in which a ratio of a particle size of toner matrix particles to a particle size of abrasive fine particles is controlled by fixing abrasive fine particles of alumina and zirconia onto the surface of the toner matrix particles. This technique exerts an excellent effect onto the surface of the photoconductor and does not require to assemble a large system such as cleaning brush and is capable of size reduction of the apparatus, and is therefore effective to image blurring, image density and fog.

However, in aforementioned Patent Document 13, Patent Document 14 and Patent Document 15, since the inorganic metal oxides have large volume resistivity value, when a magnetic one-component jumping development system is used, it is difficult to form a toner thin layer on a developing sleeve. Under an operating environment such as low temperature and low humidity environment at which charge is likely to increase, poor toner thin layer is formed and therefore it is impossible to sufficiently satisfy high resolution and high image quality at the initial stage and for a long period.

Patent Document 16 proposes a combination system of low resistance conductive abrasive particles and high resistance conductive abrasive particles. However, a weight ratio of the high resistance titanium oxide is the same as or more than that of the low resistance titanium oxide. Therefore, in an electrophotographic printer and a printing machine, which are equipped with an a-Si photoconductor, formation of black spots on the photoconductor is caused by discharge leak because of chargeup due to high resistance titanium oxide, and thus causing image defects.
Patent Document 1: U.S. Pat. No. 2,874,063
Patent Document 2: U.S. Pat. No. 2,618,552
Patent Document 3: U.S. Pat. No. 3,909,258
Patent Document 4: Japanese Unexamined Patent Publication No. 55-18656
Patent Document 5: Japanese Patent Publication No. 2649363
Patent Document 6: Japanese Patent Publication No. 2713716
Patent Document 7: Japanese Unexamined Patent Publication No. 2003-149857
Patent Document 8: Japanese Unexamined Patent Publication No. 2002-287391
Patent Document 9: Japanese Unexamined Patent Publication No. 2003-156871
Patent Document 10: Japanese Unexamined Patent Publication No. 2002-72544 (claim 1)
Patent Document 11: Japanese Unexamined Patent Publication No. 2003-270838 (claims 1, 5 and 7)
Patent Document 12: Japanese Unexamined Patent Publication No. 2002-318464
Patent Document 13: Japanese Unexamined Patent Publication No. 52-135739
Patent Document 14: Japanese Unexamined Patent Publication No. 10-3177
Patent Document 15: Japanese Unexamined Patent Publication No. 5-181306
Patent Document 16: Japanese Unexamined Patent Publication No. 2001-318488

### DISCLOSURE OF THE INVENTION

### Problem to be Solved by the Invention

An object of the present invention is to provide a magnetic one-component toner for development of an electrostatic latent image and image forming method, capable of preventing dielectric breakdown from causing on the surface of a photoconductor in a magnetic one-component jumping development system in which an amorphous silicone (a-Si) photoconductor having a thickness of 30 μm or less as a latent image support, a developer carrier having comparatively small ten-point average roughness Rz of the surface of a sleeve, and a cleaning blade as a cleaning means for removing the toner from the surface of the photoconductor are used.

### Means for Solving the Problem

With speedup of an image forming apparatus, a linear velocity of a photoconductor also increases and therefore the toner accumulated between the photoconductor and the cleaning blade causes frictional electrification, and thus causing a severe problem that dielectric breakdown is likely to arise on the surface of the photoconductor. For the purpose of preventing the dielectric breakdown and maintaining image characteristics at a good state, the present invention has been made. The present inventors have intensively studied so as to achieve the above object and found a novel fact that, by using a magnetic one-component toner for development of an electrostatic latent image in which an external additive is an inorganic metal oxide having a predetermined volume resistivity value, particularly the inorganic metal oxide is titanium oxide having a predetermined liberation rate and the titanium oxide is composed of a low resistance titanium oxide having a predetermined volume resistivity value and a high resistance titanium oxide, an also the content of the low resistance titanium oxide is more than that of the high resistance titanium oxide in the above development system, when the toner accumulated between an a-Si photoconductor and a cleaning blade is charged by friction with the tip portion of the blade, the charge amount can be suppressed to a small amount and also formation of abnormal images due to the occurrence of dielectric breakdown on the surface of the photoconductor can be prevented by making it possible to discharge before reaching to the potential at which dielectric breakdown to an amorphous photoconductor arises. Thus, the present invention has been completed.

That is, the magnetic one-component toner for development of an electrostatic latent image of the present invention is used in a magnetic one-component jumping development system in which electrostatic latent images formed on a latent image support are developed by a developer carrier, by using an amorphous silicone photoconductor having a thickness of 30 μm or less as the latent image support, a developer carrier having comparatively small ten-point average roughness Rz of the surface of a sleeve and a cleaning blade as a cleaning means for removing the toner from the surface of the photoconductor, and is characterized in that an inorganic metal oxide having a volume resistivity value within a range from 10⁰ to 10⁷Ω·cm, as an external additive, is added to the toner.

The inorganic metal oxide is preferably added in an amount within a range from 0.5 to 5.0% by mass based on the toner.

The inorganic metal oxide is preferably titanium oxide and a liberation rate of the titanium oxide is preferably within a range from 10 to 22%.

In case of using a toner containing titanium oxide having a liberation rate which is not within a predetermined range (for example, liberation rate of 4%), when images are continuously formed, dielectric breakdown of the surface of the photoconductor arises and undesired black spots are formed on output images. Even if such a toner is used, when a cleaning blade is removed and images are continuously formed, undesired black spots are not formed in images formed. Therefore, we guess that undesired black spots are formed in images formed because the toner retained the contact portion between a cleaning blade and a photoconductor is abnormally charged and discharging occurs between the toner and the surface of the photoconductor occurs, thus causing dielectric breakdown of a photosensitive layer on the surface of the photoconductor.

It is preferred that a low resistance titanium oxide having a volume resistivity value within a range from 10⁰ to 10⁷Ω·cm is selected as the titanium oxide and the low resistance titanium oxide is used in combination with a high resistance titanium oxide having a volume resistivity value within a range from 10⁸ to 10¹³Ω·cm in a mass ratio of the low resistance titanium oxide and the high resistance titanium oxide within a range from 1.3:1 to 4:1. In this combination, a ratio of a volume resistivity value between the high resistance titanium oxide and the low resistance titanium oxide (volume resistivity value of the high resistance titanium oxide/volume resistivity value of the low resistance titanium oxide) is preferably 10² or more.

The image forming method of the present invention is used in a magnetic one-component jumping development system in which electrostatic latent images formed on a latent image support are developed by a developer carrier, the latent image support is an amorphous silicone photoconductor having a thickness of 30 μm or less, ten-point average roughness Rz of the surface of a sleeve of the developer carrier is from 2.0 to 6.0 μm, a cleaning means for removing the toner from the surface of the photoconductor is a cleaning blade, characterized in that the toner used is the above magnetic one-component toner for development of an electrostatic latent image.

### EFFECT OF THE INVENTION

Regarding the magnetic one-component toner for development of an electrostatic latent image and image forming method of the present invention, since an external additive to be externally added to the toner is an inorganic metal oxide having a predetermined volume resistivity value, particularly the inorganic metal oxide is titanium oxide having a predetermined liberation rate and is composed of a predetermined low resistance titanium oxide and a predetermined high resistance titanium oxide, it is possible to suppress frictional electrification between the toner and the cleaning blade and to discharge before reaching to the potential at which dielectric breakdown to an amorphous photoconductor arises, and thus making it possible to obtain clear images which are free from abnormal images due to dielectric breakdown of the photoconductor. As a result, there is exerted the effect of obtaining image quality for a long period, to say nothing of the case at the initial stage. Particularly, when the predetermined low resistance titanium oxide is used in combination with the high resistance titanium oxide, durability can be ensured for a long period as compared with the case of using a predetermined low resistance titanium oxide alone. Since the titanium oxide is not excessively liberated, even if environmental variation (particularly, under low temperature and low humidity environment) arises, formation of a toner thin layer on the sleeve does not become unstable because of charge agglomeration of the overcharged toner.

### PREFERRED EMBODIMENTS FOR PRACTICING THE INVENTION

<Image Forming Method>

### (Image Forming Apparatus)

The present invention will now be described in detail with reference to the accompanying drawings. FIG. 1 is a schematic view showing the vicinity of a photoconductor of an image forming apparatus used in the image forming method of the present invention. As shown in FIG. 1, this image forming apparatus is provided with a development system of a magnetic one-component jumping development system, and a positive charging amorphous silicone (a-Si) photoconductor drum 11 is used as a latent image support. Around the a-Si photoconductor drum 11, a scorotron charger 12, an exposure device 13, a processor 14, a transfer roll 15, a cleaning blade (cleaning means) 16 and a destaticizing lamp (erase means) 17 are arranged.

In this image forming apparatus, the a-Si photoconductor drum 11 is charged by the scorotron charger 12 and exposure is conducted by a light signal converted based on the printing data to form electrostatic latent images on the photoconductor drum 11. On the other hand, in the processor 14, a toner is conveyed by rotation of a developing sleeve 14a (developer carrier) comprising a built-in magnet roller (not shown) which is arranged facing the photoconductor drum 11 and fixed inside, and this toner passes through the space between a magnetic blade (not shown) and the developing sleeve 14a, thereby forming a toner thin layer on the surface of the developing sleeve 14a. Then, the toner is fed onto the photoconductor drum 11 from the toner thin layer and the electrostatic latent images formed on the photoconductor drum 11 are developed.

The developed toner images are transferred to a transfer material (printing paper, etc.) by the transfer roll 15. On the other hand, the toner (waste toner) remained on the surface of the photoconductor drum 11 without being transferred to the transfer material is removed by the cleaning blade 16. This waste toner is temporarily stayed in the vicinity of the tip portion of the cleaning blade 16, transferred to the side of the carrying member of the screw roller (not shown) while being slowly extruded by the following waste toner, and then conveyed to a waste toner container (not shown). After image charge is removed from the surface of the photoconductor drum 11, from which the waste toner was removed, by a staticizing lamp 17.

(Photoconductor Drum)

FIG. 2 is an enlarge sectional view of a portion of the a-Si photoconductor drum 11. As shown in FIG. 2, as the photoconductor drum 11, a multi-layered photoconductor drum is preferably used, which comprises a conductive substrate 21, and a carrier obstruction layer 20, a photosensitive layer 19 and a surface protective layer 18 laminated on the conductive substrate 21.

In the present invention, unlike a conventional a-Si photoconductor drum, a-Si photoconductor drum 11 in the form of a thin film is used. The thickness of the photoconductor 11 is 30 μm or less, and preferably from 10 to 30 μm. In this embodiment, the thickness of the a-Si photoconductor drum 11 means the thickness from the surface of the conductive substrate 21 as a base material to the surface of the photoconductor drum 11, that is, the total thickness of the carrier obstruction layer 20, the photosensitive layer 19 and the surface protective layer 18.

When the thickness of the photoconductor drum 11 exceeds 30 μm, since a traveling speed of a heat carrier increases, dark decay characteristics (charge retentivity per hour of the photosensitive layer in a dark place) deteriorate and flow of the latent images toward the rotation direction of the photoconductor is likely to occur, resulting in deterioration of resolution. It is publicly known that, in not only the a-Si photoconductor, but also an organic photoconductor (OPC), resolution is improved as the thickness of the photoconductor decreases. In view of the cost, as the thickness of the photoconductor increases, the film forming time increases and probability of adhesion of foreign matters increases, resulting in low production yield. Therefore, as the thickness of the photoconductor decreases, the cost is low and also quality becomes stable. On the other hand, when the thickness of the photoconductor drum 11 is less than 10 μm, chargeability for the photoconductor deteriorates and it may becomes difficult to obtain a predetermined surface potential. Also irregular reflection of laser light on the surface of the conductive substrate 21 may cause defects such as interference fringe in a half pattern. Therefore, the thickness of the photoconductor drum 11 is preferably within a range from 10 to 30 μm in view of chargeability, withstand voltage, dark decay characteristics, production cost and quality.

In more preferable aspect of the photoconductor drum 11, the thickness of the surface protective layer 18 is 20,000 Å or less, and preferably from 5,000 to 15,000 Å. When the thickness of the surface protective layer 18 is less than 5,000 Å, withstand voltage characteristics against inflow of negative current having polarity, which is reverse to charge polarity from the transfer roll 15, deteriorate and thus the surface protective layer 18 may deteriorate at the easily stage of printing of 15,000 sheets or less. On the other hand, when the thickness of the surface protective layer 18 exceeds 20000 Å, the film forming time increases and it becomes disadvantageous in view of the cost. Therefore, the thickness of the surface protective layer 18 is preferably adjusted within a range from 5000 to 15000 Å in view of a balance between chargeability, abrasion resistance, environment resistance and film forming time.

FIG. 3 is a graph showing a relation between the thickness of a photoconductor drum and the dielectric breakdown voltage. As shown in FIG. 3, as the thickness increases, the voltage at which dielectric breakdown of the photosensitive layer begins to occur increases, and as the thickness decreases, the voltage at which dielectric breakdown begins to occur decreases. As described above, generation of black spots on images by dielectric breakdown of the photosensitive layer largely depends on the thickness of the photoconductor. Therefore, in a development system in which the photoconductor drum 11 having a small thickness such as 30 μm or less, there is high possibility of the occurrence of dielectric breakdown even at low voltage, and therefore the image forming method of the present invention capable of preventing overcharge is effective.

The material (photosensitive layer material) constituting the photosensitive layer 19 is not specifically limited as long as it is an amorphous silicone (a-Si). Examples of preferable material include inorganic materials such as a-Si, a-SiC, a-SiO and a-SiON. Among these materials, a-SiC is suited for use as a photosensitive layer material in this embodiment because it has particularly high resistance and higher chargeability, abrasion resistance and environment resistance can be obtained.

When a-SiC is used, a ratio of Si and C (carbon) is preferably within a predetermined range. Such a-SiC is a-Si_{1-X}C_{X} (X is from 0.3 to less than 1), and preferably a-Si_{1-X}C_{X} (X is from 0.5 to 0.95 or less). The a-SiC in which the ratio of Si and C is within the above range shows particularly high resistance of 10¹² to 10¹³Ω·cm, and shows less flow of latent image charge in the photoconductor direction on the surface of the photoconductor, and is also excellent in retainability of electrostatic latent images and moisture resistance.

In general, surface resistance of OPC is 10¹³Ω/□ order and is higher than surface resistance (10⁸Ω/□ order) of the a-Si photoconductor and is less likely to cause dielectric breakdown, and therefore leakblack spots are less likely to be generated and the a-Si photoconductor is excellent in abrasion resistance as compared with OPC. Therefore, it is possible to simultaneously realize prevention of dielectric breakdown and improvement of abrasion resistance by using the image forming method of the present invention, capable of preventing overcharge in the development system using an a-Si photoconductor.

The surface potential (charge potential) of the a-Si photoconductor drum 11 is adjusted within a range from +200 to +500 V, and preferably from +200 to +300 V. When the surface potential is less than +200, an electric field for development becomes insufficient and it becomes difficult to ensure image density. On the other hand, when the surface potential exceeds +500, chargeability is insufficient depending on the thickness of the photoconductor drum 11 and black spots on images as a result of dielectric breakdown of the photosensitive layer are likely to be generated, and also the amount of ozone generated increases. When the thickness of the photoconductor 11 is decreased, chargeability of the photoconductor drum 11 tends to deteriorate. Therefore, the surface potential of the surface of the a-Si photoconductor drum 11 is preferably within the above range in view of a balance between developing properties and chargeability of the photoconductor.

In a conventional image forming method, when a linear velocity of the photoconductor drum increases, frictional electrification of the toner is likely to occur and therefore dielectric breakdown is likely to occur. According to the present invention, even if the linear velocity is large, for example, 400˜500 mm/sec, dielectric breakdown can be prevented from occurring.

(Processor)

The ten-point average roughness Rz of the surface of the developing sleeve 14a is preferably 2.0 μm or more and 6.0 μm or less. When the ten-point average roughness Rz is less than 2.0 μm, image density may be lowered by a decrease in a toner conveying force. When Rz exceeds 6.0 μm, the image quality deteriorates and leak from a protrusion of the surface of the sleeve 14a to the photoconductor drum 11 occurs to form image black spots, and thus image quality may deteriorate. The ten-point average roughness Rz can be measured, for example, by using a surface roughness measuring apparatus “Surfcoader SE-30D” manufactured by Kosaka Laboratory Ltd.

As the material for the developing sleeve 14a, for example, aluminum and, stainless steel (SUS) can be used. Taking account of high durability, SUS is preferably used as the material for the sleeve and, for example, SUS303, SUS304, SUS305 and SUS316 can be used. It is more preferable to use SUS305 which is feebly-magnetic and is easily worked.

(Charger)

The scorotron charger 12 is composed of a shield case, a corona wire and a grid, and the distance between the corona wire and the grid is preferably set within a range from 5.3 to 6.3 mm. The distance between the grid and the photoconductor drum 11 is preferably from 0.4 to 0.8 mm. When this distance is less than 0.4 mm, spark discharge may occurs and, when the distance exceeds 0.8 mm, chargeability deteriorates

(Transfer Roll)

The transfer roll 15 is contacted with the photoconductor drum 11 and is preferably rotated by driving in a linear velocity which is different from that of the photoconductor drum 11 by 3 to 5%. When the difference in the linear velocity is less than 3%, transferability deteriorates and dropout may occur. On the other hand, when the difference in the linear velocity exceeds 5%, slip between the transfer roll 15 and the photoconductor drum 11 increases and jitter may increase.

The material used for the transfer roll 15 is preferably foamed EPDM (foam of an ethylene-propylene-diene tercopolymer). By using the foam, the toner contaminated in case of paper jam enters into bubbles and therefore marking back of an initial paper can be prevented after operating again. By using a foam-based material, it is not necessary to clean the transfer roll 15 and the cost can be reduced. The rubber hardness of the transfer roll 15 is preferably 35°±5° (Aska C: The Society of Rubber Industry, Japan standard specification “Model SRIS-0101C”). When the rubber hardness is less than 30°, poor transfer is generated and, when the rubber hardness is more than 40°, nip with the photoconductor drum 11 becomes small and a conveying force decreases.

(Cleaning Blade)

In this embodiment, as a cleaning means of the surface of the photoconductor drum 11, a cleaning blade 16 is used. This cleaning blade 16 is arranged at the downstream as compared with the transfer roll 15 in the rotation direction of the photoconductor drum 11, and the tip portion is contacted with the photoconductor drum 11. Thus, it is possible to remove the waste toner remained on the surface of the photoconductor drum 11 without being transferred to the transfer material.

The cleaning blade 16 is preferably an elastic blade having elasticity. Thus, it is possible to prevent the surface of the photoconductor drum 11 from scratching. Examples of the elastic material include urethane rubber, silicone rubber, and resin having elasticity. The cleaning blade 16 can be obtained by forming the elastic material into a blade, or mounting an elastic material to the tip portion of a blade made of metal.

<Magnetic One-Component Toner>

The magnetic one-component toner for development of an electrostatic latent image of the present invention is obtained by dispersing various toner compounding agents such as coloring agents in a binder resin.

### (Binder Resin)

The binder resin used in the toner of the present invention is not specifically limited and, for example, thermoplastic resins such as styrene-based resin, acrylic resin, styrene-acrylic copolymer, polyethylene-based resin, polypropylene-based resin, vinyl chloride-based resin, polyester-based resin, polyamide-based resin, polyurethane-based resin, polyvinyl alcohol-based resin, vinyl ether-based resin, N-vinyl-based resin and styrene-butadiene resin are preferably used.

More specifically, the polystyrene-based resin may be a homopolymer of styrene, or a copolymer of styrene and the other copolymerizable monomer. Examples of the copolymerizable monomer include p-chlorostyrene; vinylnaphthalene; ethylenically unsaturated monoolefins such as ethylene, propylene, butylenes and isobutylene; vinyl halides such as vinyl chloride, vinyl bromide and vinyl fluoride; vinyl esters such as vinyl acetate, vinyl propionate, vinyl benzoate and vinyl butyrate; (meth)acrylate esters such as methyl acrylate, ethyl acrylate, n-butyl acrylate, isobutyl acrylate, dodecyl acrylate, n-octyl acrylate, 2-chloroethyl acrylate, phenyl acrylate, α-chloromethyl acrylate, methmethyl acrylate, methethyl acrylate and butyl methacrylate; other acrylic acid derivatives such as acrylonitrile, methacrylonitrile and acrylamide; vinyl ethers such as vinyl methyl ether and vinyl isobutyl ether; vinyl ketones such as vinyl methyl ketone, vinyl ethyl ketone and methyl isopropenyl ketone; and N-vinyl compounds such as N-vinylpyrrole, N-vinylcarbazole, N-vinylindole and N-vinyl pyrrolidone. These monomers may be used alone, or two or more kinds may be copolymerized with a styrene monomer.

The polyester-based resin may be any one which is obtained by condensation polymerization or cocondensation polymerization of an alcohol component and a carboxylic acid component. Examples of the component used to synthesize the polyester-based resin include di-, tri- or polyhydric alcohol components, for example, diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol and polytetramethylene glycol; bisphenols such as bisphenol A, hydrogenated bisphenol A, polyoxyethylenated bisphenol A and polyoxypropylenated bisphenol A; and tri- or polyhydric alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane and 1,3,5-trihydroxymethylbenzene.

As the di-, tri- or polyhydric carboxylic acid component, di- or trihydric carboxylic acid, an acid anhydride thereof or a lower alkyl ester thereof is used, and examples thereof include dihydric carboxylic acids, for example, alkyl or alkenylsuccinic acids such as maleic acid, fumaric acid, citraconic acid, itaconic acid, glutaconic acid, phthalic acid, isophthalic acid, teraphthalic acid, cyclohexanedicarboxylic acid, succinic acid, adipic acid, sebacic acid, azelaic acid, malonic acid, or n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid and isododecenylsuccinic acid; and tri- or polyhydric carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and enpole trimer acid. The softening point of the polyester-based resin is preferably from 80 to 150° C., and more preferably from 90 to 140° C.

The binder resin may be a thermosetting resin. By partially introducing a crosslinked structure, storage stability or shape retention of the toner, or durability can be improved without deteriorating developing properties. Therefore, it is not necessary to use 100 parts by mass of a thermoplastic resin as the binder resin of the toner, and it is preferred to add a crosslinking agent or to partially use a thermosetting resin.

Therefore, as the thermosetting resin, an epoxy-based resin and a cyanate-based resin can be used. More specifically, bisphenol A type epoxy resin, hydrogenated bisphenol A type epoxy resin, novolak type epoxy resin, polyalkylene ether type epoxy resin, cyclic aliphatic epoxy resin and cyanate resin are used alone or in combination.

In the present invention, the glass transition point (Tg) of the binder resin is preferably from 50 to 65° C., and more preferably from 50 to 60° C. When the glass transition point is lower than the above range, the resulting toners are fused with each other in the processor and storage stability deteriorates. Since the resin strength is low, the toner tends to adhere to the photoconductor. When the glass transition point is higher than the above range, low temperature developing properties of the toner deteriorate. The glass transition point of the binder resin can be determined from a turning point of a specific heat using a differential scanning calorimeter (DSC). More specifically, the glass transition point of the binder resin was determined by measuring an endothermic curve using a differential scanning calorimeter DSC-6200 manufactured by Seiko Instruments Inc. as a measuring apparatus. For example, 10 mg of a measuring sample was placed in an aluminum pan. Using an empty aluminum pan as a reference, the measurement was conducted at a measuring temperature within a range from 25 to 200° C. and a temperature raising rate of 10° C./min under a normal temperature and normal humidity, and the glass transition point was determined from the resulting endothermic curve.

(Coloring Agent)

In the toner of the present invention, similar to a publicly known one, it is possible to disperse, as a coloring agent, pigments such as carbon black and dyes such as Acid Violet in a binder resin so as to adjust a color tone. Such a coloring agent is usually added in an amount of 1 to 10 parts by mass based on 100 parts by mass of the binder resin.

(Charge Control Agent)

The charge control agent is added so that characteristics having excellent durability and stability are obtained by remarkably improving charging level and charging rise characteristics (indicator employed whether or not it is charged to a fixed charging level within a short time). When the toner is positively charged and used for development, the positive charging charge control agent can be added and, when the toner is negatively charged and used for development, a negative charging charge control agent can be added.

The charge control agent is not specifically limited and specific examples of the positive charging charge control agent include azine compounds such as pyridazine, pyrimidine, pyrazine, orthooxazine, methoxazine, paraoxazine, orthothiazine, meththiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline and quinoxaline; direct dyes composed of azine compounds, such as Azine Fast Red FC, Azine Fast Red 12BK, Azine Violet BO, Azine Brown 3G, Azine Light Brown GR, Azine Dark Green BH/C, Azine Deep Black EW and Azine Deep Black 3RL; nigrosin compounds such as nigrosin, nigrosin salt and nigrosin derivative; acid dyes composed of nigrosin compounds, such as nigrosin BK, nigrosin NB and nigrosin Z; metal salts of naphthenic acid or higher fatty acid; alkoxylated amine; alkylamide; and quaternary ammonium salts such as benzylmethylhexyldecyl ammonium and decyltrimethyl ammonium chloride, and these charge control agents may be used alone or in combination. The nigrosin compound is best suited for use as a positive charging toner because excellent charging rise characteristics are obtained.

Also a quaternary ammonium salt, a carboxylate, or a resin or oligomer having a carboxyl group as a functional group can be used as the positive charging charge control agent. More specifically, styrene-based resin having a quaternary ammonium salt, acrylic resin having a quaternary ammonium salt, styrene-acrylic resin having a quaternary ammonium salt, a polyester-based resin having a quaternary ammonium salt, a styrene-based resin having a carboxylate, acrylic resin having a carboxylate, styrene-acrylic resin having a carboxylate, polyester-based resin having a carboxylate, polystyrene-based resin having a carboxyl group, an acrylic resin having a carboxyl group, styrene-acrylic resin having a carboxyl group and a polyester-based resin having a carboxyl group are used alone or in combination.

Particularly, a styrene-acrylic copolymerizable resin having a quaternary ammonium salt as a functional group is best suited because the charge amount can be easily adjusted within a desired range. In this case, it is preferred to copolymerize with the above styrene unit. Examples of the acrylic comonomer include (meth)acrylic acid alkyl esters such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate and iso-butyl methacrylate. As the quaternary ammonium salt, a unit derived from dialkylaminoalkyl (meth)acrylate through a quaternization step is used. The dialkylaminoalkyl (meth)acrylate, from which the unit is derived, is preferably di(lower alkyl)aminoethyl (meth)acrylate such as dimethylaminoethyl (meth)acrylate, diethylaminoethyl (meth)acrylate, dipropylaminoethyl (meth)acrylate or dibutylaminoethyl (meth)acrylate; or dimethyl methacrylamide or dimethylaminopropyl methacrylamide. It is also possible to use a hydroxy group-containing polymerizable monomer such as hydroxyethyl (meth)acrylate, hydroxypropyl (meth)acrylate, 2-hydroxybutyl (meth)acrylate or N-methylol (meth)acrylamide in combination on polymerization.

As the charge control agent which exhibits negative chargeability, for example, an organic metal complex and a chelate compound are effective and examples thereof include aluminumacetyl acetonate, iron (II) acetyl acetonate and 3,5-di-tert-butylsalicylic acid chromium. Among these, an acetylacetonemetal complex and a salicylic acid-based metal complex or salt are preferable, and a salicylic acid-based metal complex or a salicylic acid-based metal salt is particularly preferable.

The toner contains the positive chargeability or the negative charging charge control agent in the amount within a range from 1.5 to 15 parts by mass, preferably from 2.0 to 8.0 parts by mass, and more preferably from 3.0 to 7.0 parts by mass (assumed that the entire amount of the toner is 100 parts by mass). When the amount of the charge control agent is less than the above range, it may become difficult to stably charge the toner at predetermined polarity and, when electrostatic latent images are developed using this toner to form images, image density may decease and durability of the image density deteriorates. Also poor dispersion of the charge control agent may occur, and thus so-called fog may occur and severe photoconductor contamination occurs. On the other hand, when the amount of the charge control agent is more than the above range, problems such as environment resistance, poor charging at high temperature and high humidity, image defects and photoconductor contamination may arise.

(Wax)

Waxes used to improve developing properties and offset properties are not specifically limited and, for example, polyethylene wax, polypropylene wax, Teflon® wax, Fisher-Tropsch wax, paraffin wax, ester wax, montan wax and rice wax are preferably used. These waxes may be used in combination. Offset properties and image smearing can be efficiently prevented by adding these waxes.

These waxes are not specifically limited, but the amount is preferably from 1 to 5 parts by mass based on the toner (assumed that the entire amount of the toner is 100 parts by mass). When the amount of waxes is less than 1 part by mass, offset properties and image smearing can not be efficiently prevented. On the other hand, when the amount exceeds 5 parts by mass, toners are fused with each other and storage stability may deteriorate.

(Magnetic Powder)

The magnetic one-component toner for development of an electrostatic latent image of the present invention is converted into a one-component developer by adding a magnetic powder in a binder resin. Examples of the magnetic powder include per se known ones, for example, compounds containing metal, which exhibits ferromagnetism, such as iron (e.g. ferrite, magnetite, etc), cobalt or nickel, or an alloy or a compound containing an element thereof, or an alloy which does not contain a ferromagnetic element but exhibits ferromagnetism as a result of being subjected to a proper heat treatment, or chromium dioxide.

These magnetic powders are uniformly dispersed in the above binder resin in the form of fine powders having an average particle size within a range from 0.1 to 1.0 μm, and particularly from 0.1 to 0.5 μm. The magnetic powder can be used after subjecting to a surface treatment using a surface treating agent such as titanium-based coupling agent or silane-based coupling agent.

The magnetic powder is contained in the toner in the amount within a range from 35 to 60 parts by mass, and preferably from 40 to 60 parts by mass. When the magnetic powder is used in the amount which is more than the above range, durability of image density deteriorates and developing properties may drastically deteriorate. On the other hand, when the amount is less than the above range, fog in image density durability becomes worse.

Fine particles as an external additive in the form of are used so as to improve fluidity, storage stability and cleaning properties by a surface treatment of the toner, and are usually used in the amount within a range from 0.2 to 10.0 parts by mass based on the toner. The external addition treatment of these fine particles is conducted by dry mixing a magnetic toner with stirring. This mixing with stirring operation is preferably conducted using a Henshel mixer or a Nauter mixer so that external additives are not embedded in the toner.

(Inorganic Metal Oxide)

To the magnetic one-component toner for development of an electrostatic latent image of the present invention, an inorganic metal oxide is added as an external additive. The inorganic metal oxide is preferably alumina, titanium oxide, magnesium oxide, zinc oxide, strontium titanate or barium titanate, and titanium oxide is particularly preferable. The volume resistivity value of the inorganic metal oxide is from about 10⁰ to 10⁷Ω·cm, preferably from about 10¹ to 10⁶Ω·cm, and more preferably about 10²Ω·cm. When the volume resistivity value of the inorganic metal oxide is less than 10⁰Ω·cm, sufficient positive chargeability cannot be imparted to the toner and image density decreases. On the other hand, when the volume resistivity value exceeds 10⁷Ω·cm, the charge amount is too large and chargeup in durability arises, and also image density decreases and durability deteriorates. Because of excess chargeup of the toner, discharge breakdown to the a-Si photoconductor occurs and black spots are formed on images.

The volume resistivity value of the inorganic metal oxide can be determined at an applied voltage DC10 V while applying a load of 1 kg using “R8340A ULTRA HIGH RESISTANCE METER” manufactured by ADVANTEST CORPORATION.

The inorganic metal oxide is preferably added in the amount within a range from 0.5 to 5.0% by mass based on the toner. To the contrary, when the amount is less than 0.5% by mass, polishing degree of the surface of the photoconductor is insufficient and image blurring occurs at high temperature and high humidity because moisture absorbing substances produced by electrification cannot be sufficiently removed, resulting in image defects. When the amount exceeds 5.0% by mass, since fluidity of the toner drastically deteriorates, problems such as decrease in image density and deterioration of durability arise. This inorganic metal oxide preferably has an average particle size of 0.01 to 1 μm.

As is described in the following examples, the volume resistivity value of the inorganic metal oxide is adjusted by forming a coating layer made of tin oxide and antimony oxide on the surface of the inorganic metal oxide and varying the thickness of the coating layer formed, or varying the content ratio of tin oxide to antimony oxide.

(Liberation Rate of the Titanium Oxide)

To the magnetic one-component toner for development of an electrostatic latent image of the present invention, the inorganic metal oxide is added as an external additive. Titanium oxide is preferably as the inorganic metal oxide and the liberation rate of the titanium oxide is within a range from 10 to 22%. Consequently, fine particles of the titanium oxide can be liberated so as not to cause poor formation of the toner thin layer to matrix particles of the toner, and also can suppress overcharge of the toner and prevent dielectric breakdown of the surface of the photoconductor. On the other hand, when the liberation rate exceeds 22%, the titanium oxide liberated on the developing sleeve may serve as a nucleus thereby to cause fatal image defects. When the liberation rate is less than 10%, the toner is overcharged and dielectric breakdown may occur on the surface of the photoconductor.

The liberation rate is a value determined from the results obtained by analysis of the toner using a particle analyzer. That is, it is a ratio of titanium atoms derived from liberated titanium oxide fine particles to carbon atoms derived from toner matrix particles and, for example, it can be measured by toner analytical method described in “Toner Analysis by New Method for Evaluation of External Addition, Particle Analyzer”, Japan Hardcopy '97 Collected Papers, Annual Conference of the Imaging Society of Japan (95 times in total). This analytical method is a method in which toner particles are excited by introducing toner particles into to plasma and analysis is conducted by detecting an emission spectrum accompanied by excitation. According to this analytical method, an emission spectrum accompanied by excitation of plural elements can be simultaneously detected and also periodicity of the emission spectrum can be measured. This analytical method will now be described in detail with reference to the accompanying drawings.

FIG. 4(a) is a schematic view showing a state where titanium oxide fine particles adhere to toner matrix particles, and FIG. 4(b) is a graph showing a relation between the time and the emission intensity. FIG. 5(a) is a schematic view showing a state where titanium oxide fine particles 34 are liberated from toner matrix particles 33, and FIG. 5(b) is a graph showing a relation between the time and the emission intensity.

As shown in FIG. 4(a), toner particles 31 obtained by adhering titanium oxide fine particles, as an external additive, to toner matrix particles are introduced into plasma 32, toner matrix particles and titanium oxide fine particles are simultaneously introduced into plasma 32. In this case, as shown in FIG. 4(b), toner matrix particles and titanium oxide fine particles simultaneously emit light. In case of simultaneously emitting light, it indicates a state where toner matrix particles are synchronized with titanium oxide fine particles, that is, a state where titanium oxide adheres to toner matrix particles and is not liberated.

As shown in FIG. 5(a), when titanium oxide fine particles 34 do not adhere to the toner matrix particles 33 (liberated state), the toner matrix particles 33 and the titanium oxide fine particles 34 are separately introduced into plasma 32. In this case, similar to the above case, both of the toner matrix particles 33 and the titanium oxide fine particles 34 emit light, but timing is different. For example, as shown in FIG. 5(b), the titanium oxide fine particles emit light prior to the toner matrix particles. In this case, it means that the titanium oxide fine particles 34 is introduced into plasma 32 prior to the toner matrix particles 33. As described above, when the toner matrix particles 33 and the titanium oxide fine particles 34 emit light separately, the toner matrix particles 33 are synchronized with the titanium oxide fine particles 34, that is, they are in an asynchronized state. In this asynchronized state, the titanium oxide fine particles 34 do not adhere to the toner matrix particles 33 and it indicates a liberated state.

The liberation rate of the titanium oxide in the present invention can be measured by the above measuring method using an apparatus manufactured by HORIBA, Ltd. under the trade name of “Particle Analyzer System DP-1000”.

The amount of the titanium oxide is preferably from 0.5 to 5.0 parts by mass based on 100 parts by mass of the toner matrix particles. When the amount is less than the above range, the polishing effect is lowered and photoconductor contamination occurs and also dielectric breakdown of the surface of the photoconductor and poor formation of the thin layer may occur. On the other hand, when the amount is more than the above range, the titanium oxide does not strongly adhere onto the surface of the toner and the liberation rate of the titanium oxide increases, resulting in an adverse influence on image characteristics such as fog and poor formation of the thin layer.

The titanium oxide is preferably subjected to a surface treatment using a hydrophobizing agent so as to impart hydrophobicity. Consequently, it is possible to stably exert various performances of the toner to environmental variation, particularly humidity variation. The hydrophobizing agent for the surface treatment is not specifically limited and various known hydrophobizing agents such as titanate-based coupling agent can be used. When it is used as the external additive without being subjected to the hydrophobizing treatment, large decrease in image density may occur in the high humidity environment.

(Low Resistance and High Resistance Titanium Oxides)

To the magnetic one-component toner for development of an electrostatic latent image of the present invention, a titanium oxide comprising a low resistance titanium oxide and a high resistance titanium oxide is more preferably added as the external additive. Consequently, the low resistance titanium oxide suppresses generation of black spots of on an amorphous silicone drum and also the high resistance titanium oxide suppresses generation of image defects by poor charging. That is, it is intended to separate a function. The content of the low resistance titanium oxide is more than that of the high resistance titanium oxide. Specifically, a mass ratio of the low resistance titanium oxide to the high resistance titanium oxide is from 1.3:1 to 4:1, and preferably from 1.3:1 to 2.5:1. On the other hand, when the content of the high resistance titanium oxide is more than that of the low resistance titanium oxide, chargeup due to the high resistance titanium oxide drastically appears and discharge leak to the amorphous silicone drum occurs to form black spots, resulting in image defects.

The volume resistivity value of the low resistance titanium oxide is within a range from 10⁰ to 10⁷Ω·cm and the volume resistivity value of the high resistance titanium oxide is within a range from 10⁸ to 10¹³Ω·cm. To the contrary, when the volume resistivity value of the low resistance titanium oxide is less than 10⁰Ω·cm, it is difficult to impart sufficient positive chargeability to the toner and the image density decreases. The lower limit of the volume resistivity value is preferably 10²Ω·cm. When the volume resistivity value exceeds 10⁷Ω·cm, the charge amount is too large and chargeup in durability arises, and also image density decreases and durability deteriorates. Because of excess chargeup of the toner, discharge breakdown to the a-Si photoconductor occurs and black spots are formed on images. When the volume resistivity value of the high resistance titanium oxide is less than 10⁸Ω·cm, a role of imparting proper charge of the high resistance titanium oxide becomes insufficient and image defects such as decrease in image density arise. When the volume resistivity value exceeds 10¹³Ω·cm, since the charge amount is too high, and chargeup in durability arises, and also image density decreases and durability deteriorates. Because of excess chargeup of the toner, discharge breakdown to the a-Si photoconductor occurs and black spots are formed on images.

The total amount of the low resistance titanium oxide and the high resistance titanium oxide is preferably adjusted within a range from 0.5 to 5.0% by mass based on the toner. To the contrary, when the total amount is less than 0.5% by mass, polishing degree is insufficient and image blurring occurs at high temperature and high humidity, resulting in image defects. When the total amount exceeds 5.0% by mass, since fluidity of the toner drastically deteriorates, problems such as decrease in image density and deterioration of durability arise.

When these titanium oxides are added to the toner as the external additive, a ratio of a volume resistivity value between the high resistance titanium oxide and the low resistance titanium oxide (volume resistivity value of the high resistance titanium oxide/volume resistivity value of the low resistance titanium oxide) is preferably 10² or more. Consequently, a black spot generation suppressing function of an amorphous silicone drum due to the low resistance titanium oxide and an image defect generation suppressing function of the high resistance titanium oxide are well balanced. When the above ratio is less than 10², since the volume resistivity value of the low resistance titanium oxide is too closer to that of the high resistance titanium oxide so as to achieve well balanced functions, it is not preferred. The volume resistivity value of the titanium oxide can be determined at an applied voltage DC10 V while applying a load of 1 kg using “R8340A ULTRA HIGH RESISTANCE METER” manufactured by ADVANTEST CORPORATION.

The surface of the low resistance titanium oxide and that of the high resistance titanium oxide may be treated with a titanate-based coupling agent. Since hydrophobic groups can be easily introduced into the surface of the titanium oxide by the treatment, deterioration of charging characteristics under high temperature and high humidity conditions can be prevented. Examples of the titanate-based coupling agent include propyltrimethoxy titanium, propyldimethoxymethyl titanium, propyltriethoxy titanium, butyltrimethoxy titanium, butyldimethoxymethyl titanium, butyltriethoxy titanium, vinyltrimethoxy titanium, vinyldimethoxymethyl titanium, vinyltriethoxy titanium, vinyldiethoxymethyl titanium, hexyltrimethoxy titanium, hexyldimethoxymethyl titanium, hexyltriethoxy titanium, hexyldiethoxymethyl titanium, phenyltrimethoxy titanium, phenyldimethoxymethyl titanium, phenyltriethoxy titanium, phenyldiethoxymethyl titanium, γ-glycidoxypropyltrimethoxy titanium, γ-glycidoxypropyldimethoxymethyl titanium, γ-glycidoxypropyltriethoxy titanium and γ-glycidoxypropyldiethoxymethyl titanium. These titanate-based coupling agents may be used alone or in combination.

When the titanium oxide is surface-treated with the titanate-based coupling agent, both of them are preferably mixed, uniformly. It is preferred to add organic solvents such as methanol, ethanol, methyl ethyl ketone and toluene so as to uniformly mix.

In the magnetic one-component toner for development of an electrostatic latent image of the present invention, the surface of toner particles can be treated with colloidal silica or hydrophobic silica, in addition to the titanium oxide, for the purpose of improving fluidity, storage stability and cleaning properties. The silica is usually used in an amount of 0.1 to 5.0% by mass based on the toner.

The method for producing a magnetic one-component toner for development of an electrostatic latent image of the present invention will now be described. The magnetic one-component toner for development of an electrostatic latent image of the present invention can be obtained by mixing a binder resin with various toner compounding agents such as charge control agent, and melt-kneading the mixture using a kneader such as extruder, followed by cooling, grounding and further classification. The average particle size of this toner is usually adjusted within a range from about 5 to 10 μm by classification and particle size control. The external addition treatment of the titanium oxide and silica fine particles is conducted by dry mixing a magnetic toner with stirring. This mixing with stirring operation is preferably conducted using a Henshel mixer or a Nauter mixer so that external additives are not embedded in the toner.

The magnetic one-component toner for development of an electrostatic latent image of the present invention will now be described in detail by way of the following examples and comparative examples, but the present invention is not limited to only examples.

### Example 1

### Sample No. 1

### [Preparation of Titanium Oxide]

A colloidal titanium compound precipitated by neutralizing a titanium tetrachloride solution with sodium hydroxide was aged, baked at 575° C. and then ground by a hammer mill to obtain titanium dioxide having an average particle size of 0.25 μm. The resulting titanium dioxide was dispersed in water, mixed with sodium pyrophosphate and then wet ground using a sand mill to obtain a water soluble slurry having a titanium dioxide concentration of 50 g/l.

The slurry was heated to 80° C. and a solution prepared by dissolving an appropriate amount of tin chloride (SnCl₄.5H₂O) and antimony chloride (SbCl₃) in a 2N-hydrochloric acid solution and a 10% sodium hydroxide solution were added over 60 minutes while maintaining at the pH of the system within a range from 6 to 9 to form a coating layer made of tin oxide and antimony oxide on the surface of titanium oxide particles. The pH of the slurry was finally adjusted to 8, followed by filtration, washing and further drying (120° C.).

The dry titanium dioxide thus obtained was baked in an electric furnace at 500° C. for 60 minutes and then crushed using a jet mill thereby changing the thickness of the coating layer made of tin oxide and antimony oxide to obtain titanium oxides which exhibit various volume resistivity values shown in Table 1.

[Production of Binder Resin]

In a reactor equipped with a thermometer, a stirrer and a nitrogen introducing tube, 300 parts by mass of xylene were charged and a monomer mixture of 845 parts by mass of styrene and 155 parts by mass of n-butyl acrylate and a mixed solution of 8.5 parts by mass of di-tert-butyl peroxide (polymerization initiator) and 125 parts by mass of xylene were added in a nitrogen gas flow at 170° C. over 3 hours. After the dropwise addition, the polymerization was completed by reacting at 170° C. for one hour. Then, the reaction solution was desolvated to obtain a binder resin.

49 Parts by mass of the binder resin thus produced was mixed with 45 parts by mass of a magnetic powder (holding power: 5.0 kA/m on application of 796 kA/m, saturation magnetization: 82 Am²/kg, residual magnetization: 11 Am²/kg, number average particle size: 0.25 μm), 3 parts by mass of a wax (manufactured by Sasol Co. under the trade name of “Sasol wax H1”) and 3 parts by mass of a quaternary ammonium salt (manufactured by Orient Chemical Industries, Ltd. under the trade name of “Bontron P-51”) using a Henshel mixer, melt-kneaded using a twin-screw extruder, cooled and then coarsely ground using a hammer mill. The coarsely ground one was finely ground using a mechanical pulverizer and then classified using an air classifier to obtain a magnetic toner having a volume average particle size of 8.0 μm.

To the resulting toner powder (magnetic one-component toner), 1.0 parts by mass of a silica (manufactured by NIPPON AEROSIL CO., LTD. under the trade name of “RA-200H”) and 2.0 parts by mass of the resulting titanium oxide were externally added thereby coating onto the surface of the magnetic toner powder to obtain a magnetic one-component positive charging developer.

Using this developer and a page printer LS-3800 including an amorphous silicone photoconductor manufactured by KYOCERA Corporation (24 ppm (A4 size), linear velocity: 147 mm/sec) installed therein, initial image characteristics and durability were evaluated and the state of dielectric breakdown of a photoconductor was measured, and also charging characteristics of a magnetic toner were measured. As a latent image support, thin film amorphous silicone having a thickness of 14 μm was used. The volume resistivity value of the titanium oxide is shown in Table 1 and the evaluation results are shown in Table 2.

The volume resistivity value of the titanium oxide was measured using “R8340A ULTRA HIGH RESISTANCE METER” manufactured by ADVANTEST CORPORATION”. About 5 g of titanium oxide was weighed and put in a measuring cell and, after applying a load of 1 kg, an electrode was connected and the measurement was conducted at an applied voltage DC10 V. Under loading, the diameter of a titanium oxide sample was about 35 mm and the thickness was about 5 mm.

Methods for evaluation of respective characteristics are as follows.

(1) Charging Characteristics (Charge Amount)

4 Parts by mass of the above magnetic toner and 100 parts by mass of a ferrite carrier (FK-150, manufactured by Powdertech International Corporation) were mixed and then subjected to frictional electrification under a conventional environment for 60 minutes. The resulting charge amount (μC/g) was taken as an initial charge amount. Using the above page printer, images were formed by the developer and the charge amount of the toner when 100,000 sheets were continuously printed (printing rate: 5%) was taken as a charge amount after duration. Details of the measurement are as follows.

A magnetic toner and a ferrite carrier were mixed under a normal temperature and normal humidity environment and then subjected to frictional electrification by stirring using a ball mill for 60 minutes. The charge amount of about 100 mg of the mixture was measured using a charge amount measuring apparatus (Q/M Meter 210HS) manufactured by Trek Co. and the charge amount μC/g per 1 g of the developer was determined from a change in mass.

(2) Images Characteristics (Image Density and Fog)

Under normal temperature and normal humidity environment (20° C., 65% RH), a pattern for evaluation of images was printed by the above page printer at the initial stage to form initial image. After 100,000 sheets were continuously printed, a pattern for evaluation of images was printed again to form images after duration. Solid images were measured using a Macbeth densitometer (RD914) and also image characteristics were evaluated by visually observing fog. Image density of 1.30 or more was rated “◯” and image density of less than 1.30 was rated “X”. Fog was evaluated according to the following evaluation criteria.

◯: No fog is observed

Δ: Slight fog is observed

X: Severe fog is observed

(3) Photoconductor Dielectric Breakdown (Number of Black Spots on Photoconductor)

The number of black spots generated by dielectric breakdown on a photoconductor when 100,000 sheets are printed using the above page printer (number of dielectric breakdown of a photoconductor film relative to the number of sheets printed) was measured using a dot analyzer (manufactured by Oji Scientific Instruments under the trade name of “DA-5000S”). The black spot was measured within a range of A4 (transverse direction) and 5 mm×210 mm.

### Samples No. 2 to 4

In the same manner as in case of the sample No. 1, except that titanium oxide having the volume resistivity value shown in Table 1 was used, magnetic toners were obtained. Then, respective characteristics of these toners were evaluated in the same manner as in case of the sample No. 1. The valuation results are shown in Table 2.

### Sample No. 5

In the same manner as in case of the sample No. 1, except that strontium titanate having the volume resistivity value shown in Table 1 was used in place of the titanium oxide, a magnetic toner was obtained. Then, respective characteristics of the toner were evaluated in the same manner as in case of the sample No. 1. The valuation results are shown in Table 2.

### Sample No. 6

In the same manner as in case of the sample No. 1, except that barium titanate having the volume resistivity value shown in Table 1 was used in place of the titanium oxide, a magnetic toner was obtained. Then, respective characteristics of the toner were evaluated in the same manner as in case of the sample No. 1. The valuation results are shown in Table 2.

### Samples No. 7 to 9

In the same manner as in case of the sample No. 1, except that titanium oxide having the volume resistivity value shown in Table 1 was used, magnetic toners were obtained. Then, respective characteristics of these toners were evaluated in the same manner as in case of the sample No. 1. The valuation results are shown in Table 2.

TABLE 1

Inorganic metal oxide

| | | | Volume resistivity values |
|---|---|---|---|
| | | Composition | (Ω · cm) |
| | 1 | Titanium oxide | 1 × 10¹ |
| | 2 | Titanium oxide | 9 × 10² |
| | 3 | Titanium oxide | 4 × 10⁴ |
| | 4 | Titanium oxide | 7 × 10⁶ |
| | 5 | Strontium titanate | 3 × 10³ |
| | 6 | Barium titanate | 1 × 10⁴ |
| * | 7 | Titanium oxide | 4 × 10⁻¹ |
| * | 8 | Titanium oxide | 5 × 10⁸ |
| * | 9 | Titanium oxide | 3 × 10⁹ |

Samples marked * are out of the scope of the present invention.

TABLE 2

| | | Charge | | | | | | | | |
|---|---|---|---|---|---|---|---|---|---|---|
| | | amount | | | | | | | | |
| | | (μC/g) | | | | | | Fog | | |
| | | | After | Image density | | | | | After | |
| | | | printing | | | After printing | | | printing | Number of |
| | | | 100,000 | | | 100,000 | | | 100,000 | black spots on |
| | | Initial | sheets | Initial | | sheets | | Initial | sheets | photoconductor |
| | 1 | 10.5 | 11.6 | 1.42 | ◯ | 1.38 | ◯ | ◯ | ◯ | 0 |
| | 2 | 12.9 | 13.1 | 1.38 | ◯ | 1.37 | ◯ | ◯ | ◯ | 0 |
| | 3 | 16.1 | 16.7 | 1.41 | ◯ | 1.41 | ◯ | ◯ | ◯ | 0 |
| | 4 | 18.2 | 18.7 | 1.40 | ◯ | 1.39 | ◯ | ◯ | ◯ | 0 |
| | 5 | 13.1 | 14.2 | 1.39 | ◯ | 1.40 | ◯ | ◯ | ◯ | 0 |
| | 6 | 15.7 | 16.2 | 1.40 | ◯ | 1.41 | ◯ | ◯ | ◯ | 0 |
| * | 7 | 4.9 | 5.1 | 1.22 | X | 1.26 | X | Δ | Δ | 0 |
| * | 8 | 26.2 | 28.9 | 1.25 | X | 1.17 | X | ◯ | Δ | 523 |
| * | 9 | 34.3 | 47.7 | 1.23 | X | 1.01 | X | X | X | 1564 |

Samples marked * are out of the scope of the present invention.

As is apparent from Tables 1 and 2, in the samples Nos. 1 to 6, in which the volume resistivity value of the inorganic metal oxide is within a predetermined range, there is no problem before printing and even after printing 100,000 sheets. On the other hand, the sample No. 7 having a volume resistivity value of less than 10⁰Ω·cm shows a low toner charge amount and a low image density, and thus fog occurred. The samples No. 8 and 9 having a volume resistivity value of more than 10⁷Ω·cm show a high toner charge amount and a low image density, and thus fog occurred and dielectric breakdown occurred on the photoconductor.

### Example 2

### Sample No. 1

### <Production of Toner>

49 Parts by mass of a binder resin, 45 parts by mass of a magnetic powder, 3 parts by mass of a wax and 3 parts by mass of a positive charge control agent were mixed using a Henshel mixer (manufactured by Mitsui Miike Machinery Co., LTD. under the trade name of “FM10C/I”), melt-kneaded using a twin-screw extruder, cooled and then coarsely ground using a hammer mill. The resulting coarsely ground one was finely ground using a mechanical pulverizer and then classified using an air classifier to obtain toner matrix particles having a volume average particle size of 8.0 μm. To the resulting toner matrix particles, titanium oxide (which is No. 3 titanium oxide used in Example 1 and has a volume resistivity value of 4×10⁴Ω·cm) was added in a predetermined amount shown in Table 3 based on 100 parts by mass of the toner matrix particles and silica was added in the amount of 1 part by mass based on 100 parts by mass of the toner matrix particles, followed by mixing with stirring at the rotation speed and the stirring time shown in Table 3 using the Henshel mixer, thereby coating the titanium oxide and silica onto the surface of the toner matrix particles to obtain a magnetic one-component positive charging developer.

Details of the respective starting materials constituting the above toners are shown below.

Binder resin: styrene-acryl copolymer (low molecular weight peak molecular weight: 8,000, high molecular weight peak molecular weight: 130,500, glass transition point Tg: 55° C.)
Magnetic powder: holding power: 5.0 kA/m on application of 796 kA/m, saturation magnetization: 82 Am²/kg, residual magnetization: 11 Am²/kg, number average particle size: 0.25 μm),
Wax: manufactured by Sasol Co. under the trade name of “Sasol wax H1”
Positive charge control agent: quaternary ammonium salt (manufactured by Orient Chemical Industries, Ltd. under the trade name of “Bontron P-51”)
Titanium oxide: manufactured by Titan Kogyo Kabushiki Kaisha under the trade name of “ST-100”
Silica: manufactured by NIPPON AEROSIL CO., LTD. under the trade name of “RA-200H”

With respect to the resulting magnetic one-component positive charging toner, the liberation rate of titanium oxide was measured. The measuring method is shown below. The measurement results are shown in Table 3.

### <Method for Measuring Liberation Rate of Titanium Oxide>

Using an apparatus manufactured by HORIBA, Ltd. under the trade name of “Particle Analyzer System DP-1000”, the liberation rate of the resulting toners was measured under the following conditions.

### (Measuring Conditions)

Number of carbon atoms detected per one measurement: 2500 to 3000
Noise cut level: 1.5 or less
Sort time: 20 digits

### Gas: O₂ 0.1%, He

Analytical wavelength: carbon atom (C atom): 247.860 nm, titanium atom
(Ti atom): 334.900 nm
Channel used: carbon atom: 3 or 4, titanium atom: 1 or 2

The liberation rate of the titanium oxide was calculated by inserting “number of counts of titanium atoms (Ti atoms) which emitted light together with carbon atoms (C atoms)” and “number of counts of titanium atoms (Ti atoms) which did not emit light together with carbon atoms” into the following equation.

Liberation rate (%)=A/(A+B)×100 [Equation 1]

A: The number of titanium atoms not emitting at same time as carbon atoms

B: The number of titanium atoms emitting at same time as carbon atoms

Using this developer and a modified machine of a page printer LS-3800 including an amorphous silicone photoconductor manufactured by KYOCERA Corporation installed therein (thickness of amorphous silicone photoconductor: 20 μm, 24 sheets/min [A4 size], linear velocity: 147 mm/sec, developing sleeve of processor has ten-point average roughness Rz of 3.0 μm, material: SUS305), the state of photoconductor dielectric breakdown, state of toner thin layer on a sleeve, image characteristics and charging characteristics were evaluated. Methods for evaluating respective characteristics are shown below. The valuation results are shown in Table 4. “Initial” and “after printing 100,000 sheets” in Table 4 means the followings.

Initial: The toner is set to the above page printer and respective characteristics are evaluated immediately after outputting images.
After printing 100,000 sheets: The respective characteristics are evaluated after printing 100,000 sheets (printing rate: 5%) while continuous printing.

<Photoconductor Dielectric Breakdown (Number of Black Spots on Photoconductor)>

The number of black spots generated by dielectric breakdown on a photoconductor when 100,000 sheets were printed using the above page printer (number of dielectric breakdown of a photoconductor film relative to the number of sheets printed) was measured using a dot analyzer (manufactured by Oji Scientific Instruments under the trade name of “DA-5000S”). The black spot was measured within a range of A4 (transverse direction) and 5 mm×210 mm.

Toner Thin Layer State>

At the initial stage, the state on a sleeve was visually confirmed under low temperature and low humidity environment (10° C., 20% RH). Evaluation was conducted according to the following evaluation criteria.

◯: Thin layer is uniformly formed, adhesion onto sleeve and unevenness are not confirmed.

Δ: Some thick portions are present, layer is not slightly uniform at some portion (partial formation of poor thin layer).

X: Unevenness and adhesion onto sleeve are confirmed, layer is not uniform (poor formation of thin layer).

<Images Characteristics (Image Density and Fog)>

Under normal temperature and normal humidity environment (20° C., 65% RH), a pattern for evaluation of images was printed by the above page printer at the initial stage to form initial image. After 100,000 sheets were continuously printed, a pattern for evaluation of images was printed again to form images after duration. Solid images were measured using a Macbeth densitometer (RD914) and also image characteristics were evaluated by visually observing fog. Image density of 1.30 or more was rated “◯” and image density of less than 1.30 was rated “X”. Fog was evaluated according to the following evaluation criteria.

◯: No fog is observed.

Δ: Slight fog is observed.

X: Severe fog is observed.

<Charging Characteristics (Charge Amount)>

The charge amount of the toner on a developing sleeve assembled in a developer carrier of the page printer was measured using an suction type charge amount measuring apparatus (Q/M Meter 210HS) manufactured by Trek Co. and the charge amount μC/g per 1 g of the developer was determined from a change in weight.

<Photoconductor Surface>

Contamination on a photoconductor when 100,000 sheets were printed using the page printer was visually observed. Photoconductor contamination was evaluated according to the following evaluation criteria.

◯: Neither filming nor scratch is observed on the surface.

Δ: Trace amount of filming or micro scratch is observed.

X: Filming or scratch is observed.

### Samples Nos. 2 to 5

In the same manner as in case of the sample No. 1, except that a predetermined amount shown in Table 3 of the titanium oxide was added to the toner, followed by mixing with stirring at the rotation number and the stirring time shown in Table 3 using the Henshel mixer, magnetic one-component positive charging toners having the liberation rate shown in Table 3 were obtained. With respect to these toners, respective characteristics were evaluated in the same manner as in case of the sample No. 1. The valuation results are shown in Table 4.

TABLE 3

| | Henshel mixer | | | |
|---|---|---|---|---|
| | Rotation | Stirring | | |
| | speed | time | Amount | |
| | (rpm) | (min) | (parts by mass) | Liberation rate (%) |
| 1 | 3000 | 4.0 | 2.0 | 16.2 |
| 2 | 3000 | 5.0 | 2.0 | 11.0 |
| 3 | 2000 | 4.0 | 2.0 | 20.7 |
| 4 | 2500 | 4.0 | 0.8 | 12.1 |
| 5 | 4000 | 5.0 | 4.3 | 19.8 |

TABLE 4

| | Initial | | | | | After printing 100,000 sheets | | | | | |
|---|---|---|---|---|---|---|---|---|---|---|---|
| | Charge | | | | Toner | Charge | | | | Number of | |
| | amount | Image | | | thin | amount | Image | | | black spots on | Photoconductor |
| | (μC/g) | density | | Fog | layer | (μC/g) | density | | Fog | photoconductor | surface |
| 1 | 4.0 | 1.43 | ◯ | ◯ | ◯ | 4.8 | 1.35 | ◯ | ◯ | 0 | ◯ |
| 2 | 4.2 | 1.40 | ◯ | ◯ | ◯ | 4.6 | 1.36 | ◯ | ◯ | 0 | ◯ |
| 3 | 3.9 | 1.38 | ◯ | ◯ | ◯ | 4.8 | 1.32 | ◯ | ◯ | 0 | ◯ |
| 4 | 4.4 | 1.42 | ◯ | ◯ | ◯ | 5.0 | 1.32 | ◯ | ◯ | 0 | ◯ |
| 5 | 3.8 | 1.37 | ◯ | ◯ | ◯ | 4.5 | 1.34 | ◯ | ◯ | 0 | ◯ |

As is apparent from Table 4, in the sample No. 1 to 5, there is no problem with respect to the toner thin layer at the initial stage, the number of black spots on a photoconductor after printing 100,000 sheets and the surface of the photoconductor, and also there is no problem with respect to the charge amount, the image density and fog at the initial stage and after printing 100,000 sheets printing.

### Example 3

### Sample No. 1

### <Production of Titanium Oxide>

A colloidal titanium compound precipitated by neutralizing a titanium tetrachloride solution with sodium hydroxide was aged, baked at 575° C. and then ground by a hammer mill to obtain titanium dioxide having an average particle size of 0.25 μm. The resulting titanium dioxide was dispersed in water, mixed with sodium pyrophosphate and then wet ground using a sand mill to obtain a water soluble slurry having a titanium dioxide concentration of 50 g/l.

The slurry was heated to 80° C. and a solution prepared by dissolving an appropriate amount of tin chloride (SnCl₄.5H₂O) and antimony chloride (SbCl₃) in a 2N-hydrochloric acid solution and a 10% sodium hydroxide solution were added over 60 minutes while maintaining at the pH of the system within a range from 6 to 9 to form a coating layer made of tin oxide and antimony oxide on the surface of titanium oxide particles. The pH of the slurry was finally adjusted to 8, followed by filtration, washing and further drying (120° C.).

The dry titanium dioxide thus obtained was baked in an electric furnace at 500° C. for 60 minutes, crushed using a jet mill and then surface-treated with a titanate-based coupling agent (manufactured by Ajinomoto Fine-Techno Co., Ltd. under the trade name of “KR TTS”) to obtain a low resistance titanium oxide and a high resistance titanium oxide which exhibit various volume resistivity values shown in Table 5. Then, the low resistance titanium oxide and the high resistance titanium oxide were mixed in a predetermined amount shown in Table 5 to obtain titanium oxide.

The volume resistivity value of the titanium oxide was measured using “R8340A ULTRA HIGH RESISTANCE METER” manufactured by ADVANTEST CORPORATION”. About 5 g of a low resistance titanium oxide or a high resistance titanium oxide was weighed and put in a measuring cell and, after applying a load of 1 kg, an electrode was connected and the measurement was conducted at an applied voltage DC10 V. Under loading, the diameter of a sample of the low resistance titanium oxide or the high resistance titanium oxide was about 35 mm and the thickness was about 5 mm.

<Production of Binder Resin>

In a reactor equipped with a thermometer, a stirrer and a nitrogen introducing tube, 300 parts by mass of xylene were charged and a monomer mixture of 845 parts by mass of styrene and 155 parts by mass of n-butyl acrylate and a mixed solution of 8.5 parts by mass of di-tert-butyl peroxide (polymerization initiator) and 125 parts by mass of xylene were added in a nitrogen gas flow at 170° C. over 3 hours. After the dropwise addition, the polymerization was completed by reacting at 170° C. for one hour. Then, the reaction solution was desolvated to obtain a binder resin.

<Production of Toner>

49 Parts by mass of the binder resin thus produced was mixed with 45 parts by mass of a magnetic powder (holding power: 5.0 kA/m on application of 796 kA/m, saturation magnetization: 82 Am²/kg, residual magnetization: 11 Am²/kg, number average particle size: 0.25 μm), 3 parts by mass of a wax (manufactured by Sasol Co. under the trade name of “Sasol wax H1”) and 3 parts by mass of a quaternary ammonium salt (manufactured by Orient Chemical Industries, Ltd. under the trade name of “Bontron P-51”) using a Henshel mixer, melt-kneaded using a twin-screw extruder, cooled and then coarsely ground using a hammer mill. The coarsely ground one was finely ground using a mechanical pulverizer and then classified using an air classifier to obtain a magnetic toner having a volume average particle size of 8.0 μm.

To the resulting toner powder, 1.0 parts by mass based on the total amount of the toner powder of a silica (manufactured by NIPPON AEROSIL CO., LTD. under the trade name of “RA-200H”) and a predetermined amount shown in Table 5 based on the total amount of the toner powder of the resulting titanium oxide were externally added thereby coating onto the surface of the magnetic toner powder to obtain a magnetic one-component positive charging developer.

Using this developer and a page printer FS-3830N comprising an amorphous silicone photoconductor manufactured by KYOCERA Corporation [33 ppm (A4 size laterally passing paper), linear velocity: 210 mm/sec, linear velocity of photoconductor: 210 mm/sec, surface potential (developing position) of photoconductor: 260 V, DC developing bias: 150 V, AD developing bias: 2.7 kHz, V_{P-P}: 1.5 kV, ten-point average roughness Rz of the surface of developing sleeve=4.0 μm, material of developing sleeve: SUS316] installed therein, initial image characteristics and durability were evaluated and the state of dielectric breakdown of a photoconductor was measured, and also charging characteristics of a magnetic toner was measured. As a latent image support, thin film amorphous silicone having a thickness of 20 μm was used. Methods for evaluation and the evaluation results are shown in Table 6.

(1) Charging Characteristics (Charge Amount)

4 Parts by mass of the above toner and 100 parts by mass of a ferrite carrier (FK-150, manufactured by Powdertech International Corporation) were mixed and then subjected to frictional electrification under a normal temperature and normal humidity environment (20° C., 65% RH) for 60 minutes. The resulting charge amount (μC/g) was taken as an initial charge amount. Using the above page printer, images were formed by the developer and the charge amount of the toner when 300,000 sheets were continuously printed (printing rate: 5%) was taken as a charge amount after duration. Details of the measurement are as follows.

A toner and a ferrite carrier were mixed under a normal temperature and normal humidity environment and then subjected to frictional electrification by stirring using a ball mill for 60 minutes. The charge amount of about 100 mg of the mixture was measured using a charge amount measuring apparatus (Q/M Meter 210HS) manufactured by Trek Co. and the charge amount μC/g per 1 g of the developer was determined from a change in mass.

(2) Images Characteristics (Image Density and Fog)

Under normal temperature and normal humidity environment (20° C., 65% RH), a pattern for evaluation of images was printed by the above page printer at the initial stage to form initial image. After 300,000 sheets were continuously printed, a pattern for evaluation of images was printed again to form images after duration. Solid images were measured using a Macbeth densitometer (RD914) and also image characteristics were evaluated by visually observing fog. Image density of 1.30 or more was rated “◯” and image density of less than 1.30 was rated “X”. Fog was evaluated according to the following evaluation criteria.

◯: No fog is observed.

Δ: Slight fog is observed.

X: Severe fog is observed.

(3) Photoconductor Dielectric Breakdown (Number of Black Spots on Photoconductor)

The number of black spots generated by dielectric breakdown on a photoconductor when 300,000 sheets were printed using the above page printer (number of dielectric breakdown of a photoconductor film relative to the number of sheets printed) was measured using a dot analyzer (manufactured by Oji Scientific Instruments under the trade name of “DA-5000S”). The black spot was measured within a range of A4 (transverse direction) and 5 mm×210 mm.

(4) State of Photoconductor Contamination

Contamination on a photoconductor when 300,000 sheets were printed using the page printer was visually observed. Photoconductor contamination was evaluated according to the following evaluation criteria.

◯: Contamination is not observed.

Δ: Slight contamination is observed.

X: Severe contamination is observed.

(5) State of Toner Thin Layer

Immediately after installing, patterns for evaluation of images were printed in a low temperature and low humidity environment (10° C., 20% RH) (initial stage). After continuously printing 300,000 sheets, patterns for evaluation of images were printed again (after duration). The state of the toner thin layer on the developing sleeve was visually confirmed and the evaluation was conducted according to the following evaluation criteria.

◯: A thin layer is uniformly formed and is free from unevenness.

Δ: The thickness is not uniform, but an adverse influence is not exerted on images formed.

X: The thickness is not uniform, and an adverse influence is exerted on images formed.

### Samples Nos. 2 to 8

In the same manner as in case of the sample No. 1, except that titanium oxide having the volume resistivity value shown in Table 5 was used, magnetic one-component positive charging toners were obtained. Then, respective characteristics of these toners were evaluated in the same manner as in case of the sample No. 1. The valuation results are shown in Table 6.

TABLE 5

| | | Low resistance titanium oxide | | High resistance titanium oxide | | | |
|---|---|---|---|---|---|---|---|
| | | (LTO) | | (HTO) | | | |
| | | Volume | | Volume | | | |
| | | resistivity | | resistivity | | | |
| | | value | Amount | value | Amount | HTO (Ω · cm)/ | Total amount |
| | | (Ω · cm) | (mass %) | (Ω · cm) | (mass %) | LTO (Ω · cm) | (mass %) |
| | 1 | 4.4 × 10⁴ | 0.7 | 3.8 × 10⁹ | 0.4 | 8.6 × 10⁴ | 1.1 |
| | 2 | 4.4 × 10⁴ | 1.0 | 3.8 × 10⁹ | 0.5 | 8.6 × 10⁴ | 1.5 |
| | 3 | 4.4 × 10⁴ | 1.5 | 3.8 × 10⁹ | 1.0 | 8.6 × 10⁴ | 2.5 |
| | 4 | 2.6 × 10² | 1.0 | 3.8 × 10⁹ | 0.5 | 1.5 × 10⁷ | 1.5 |
| | 5 | 6.7 × 10⁶ | 1.0 | 3.8 × 10⁹ | 0.5 | 5.7 × 10² | 1.5 |
| | 6 | 4.4 × 10⁴ | 1.0 | 2.5 × 10⁸ | 0.5 | 5.7 × 10³ | 1.5 |
| | 7 | 4.4 × 10⁴ | 1.0 | 8.0 × 10¹² | 0.5 | 1.8 × 10⁸ | 1.5 |
| | 8 | 4.4 × 10⁴ | 0.7 | 3.8 × 10⁹ | 0.5 | 8.6 × 10⁴ | 1.2 |
| * | 9 | — | — | 3.8 × 10⁹ | 2.0 | — | 2.0 |

Sample marked * is out of the scope of the present invention.

TABLE 6

| | | Charge amount | | | | | | | | | | State of toner thin | |
|---|---|---|---|---|---|---|---|---|---|---|---|---|---|
| | | (μC/g) | | Image density | | | | Fog | | Number of | | layer | |
| | | | After | | | After | | | After | black spots | Photocon- | | After |
| | | | printing | | | printing | | | printing | on | ductor | | printing |
| | | | 300,000 | | | 300,000 | | | 300,000 | photocon- | contami- | | 300,000 |
| | | Initial | sheets | Initial | | sheets | | Initial | sheets | ductor | nation | Initial | sheets |
| | 1 | 10.1 | 11.5 | 1.41 | ◯ | 1.37 | ◯ | ◯ | ◯ | 0 | ◯ | ◯ | ◯ |
| | 2 | 12.8 | 13.0 | 1.39 | ◯ | 1.38 | ◯ | ◯ | ◯ | 0 | ◯ | ◯ | ◯ |
| | 3 | 16.3 | 16.9 | 1.40 | ◯ | 1.39 | ◯ | ◯ | ◯ | 0 | ◯ | ◯ | ◯ |
| | 4 | 11.8 | 12.1 | 1.41 | ◯ | 1.41 | ◯ | ◯ | ◯ | 0 | ◯ | ◯ | ◯ |
| | 5 | 18.3 | 18.9 | 1.40 | ◯ | 1.40 | ◯ | ◯ | ◯ | 0 | ◯ | ◯ | ◯ |
| | 6 | 17.5 | 18.1 | 1.43 | ◯ | 1.41 | ◯ | ◯ | ◯ | 0 | ◯ | ◯ | ◯ |
| | 7 | 19.8 | 19.6 | 1.41 | ◯ | 1.42 | ◯ | ◯ | ◯ | 0 | ◯ | ◯ | ◯ |
| | 8 | 11.2 | 12.3 | 1.40 | ◯ | 1.38 | ◯ | ◯ | ◯ | 0 | ◯ | ◯ | ◯ |
| * | 9 | 20.2 | 35.8 | 1.39 | ◯ | 1.13 | X | ◯ | X | 3683 | ◯ | ◯ | X |

Sample marked * is out of the scope of the present invention.

As is apparent from Table 6, in the samples Nos. 1 to 8, which satisfy the predetermined conditions of the present invention, there is no problem with respect to the charge amount, the image density, fog, the number of black spots on the photoconductor, photoconductor contamination and the state of a toner thin layer at the initial stage and even after printing 300,000 sheets. The sample No. 13 in which a low resistance titanium oxide is not externally added, showed bad results with respect to the image density after printing 300,000 sheets, fog and the state of the toner thin layer, and showed a large number of black spots on the photoconductor.

### Samples No. 10 to 12

Using the magnetic toner obtained in the sample No. 3, ten-point average roughness Rz of the surface of the sleeve of the developer carrier is explained by way of Example 3. Using this magnetic toner and the printer, a developing sleeve having different surface roughness shown in Table 7 was installed, and image characteristics and formation of a toner thin layer were evaluated. The evaluation results are shown in Table 8. Rz was measured using a surface roughness measuring apparatus “Surfcoader SE-30D” manufactured by Kosaka Laboratory Ltd.

TABLE 7

| | Roughness of the surface of |
|---|---|
| | a sleeve, Rz (μm) |
| 10 | 2.5 |
| 11 | 4.2 |
| 12 | 5.6 |

TABLE 8

| | | | | | | | State of toner | | |
|---|---|---|---|---|---|---|---|---|---|
| | Image density | | | | Fog | | thin layer | | Number of |
| | | | After printing | | | After printing | | After printing | black spots on |
| | Initial | | 300,000 sheets | | Initial | 300,000 sheets | Initial | 300,000 sheets | photoconductor |
| 10 | 1.37 | ◯ | 1.40 | ◯ | ◯ | ◯ | ◯ | ◯ | 0 |
| 11 | 1.41 | ◯ | 1.38 | ◯ | ◯ | ◯ | ◯ | ◯ | 0 |
| 12 | 1.38 | ◯ | 1.39 | ◯ | ◯ | ◯ | ◯ | ◯ | 0 |

As is apparent from Table 8, the samples Nos. 10 to 12, which satisfy the predetermined conditions of the present invention, there is no problem with respect to the mage density, fog, the state of the toner thin layer and the number of black spots on the photoconductor at the initial stage and even after printing 300,000 sheets.

### BRIEF DESCRIPTION OF THE DRAWINGS

FIG. 1 is a schematic view showing an example of an image forming apparatus.

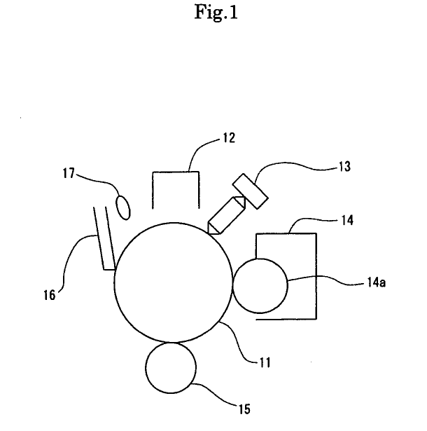

FIG. 2 is a partially enlarged sectional view showing a laminated structure of an amorphous silicone photoconductor drum.

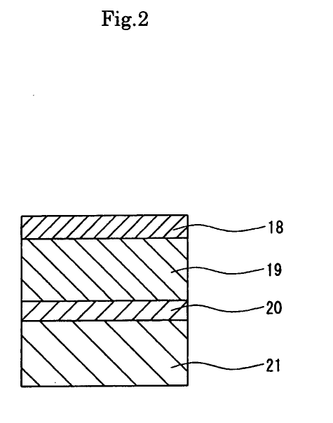

FIG. 3 is a graph showing a relation between the thickness of a photoconductor and the dielectric breakdown voltage.

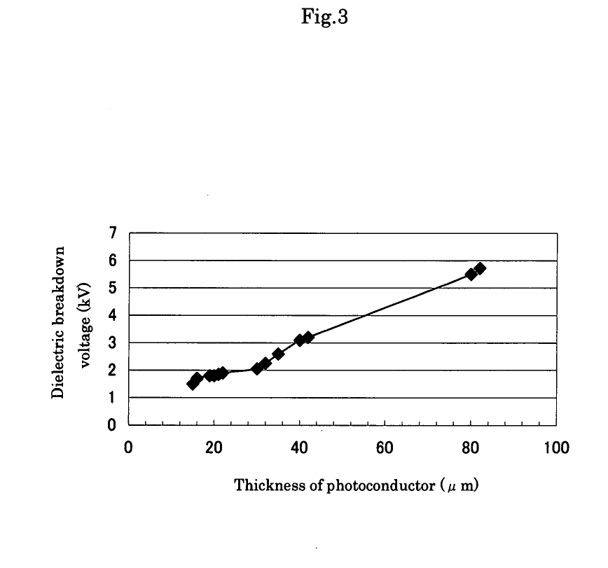

FIG. 4(a) is a schematic view showing a state where titanium oxide fine particles adhere to toner matrix particles in the method for measuring a liberation rate, and FIG. 4(b) is a graph showing a relation between the time and the emission intensity.

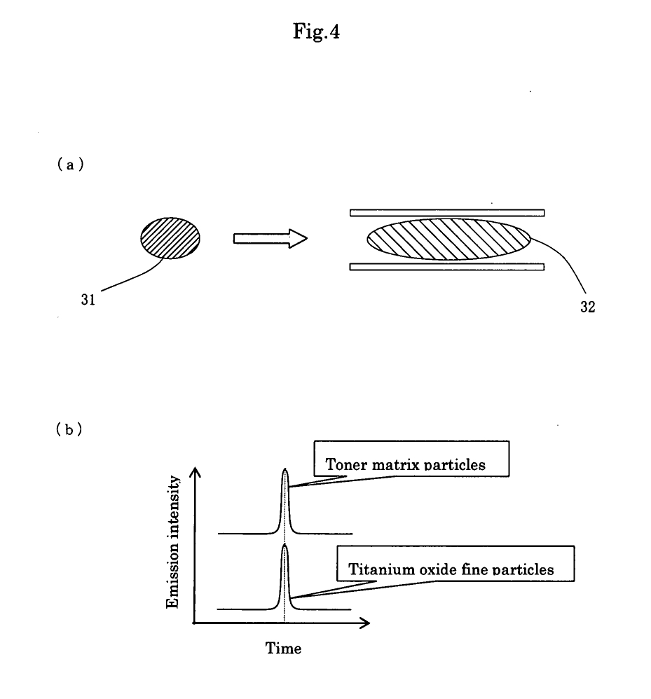

FIG. 5(a) is a schematic view showing a state where titanium oxide fine particles are liberated in the method for measuring a liberation rate, and FIG. 5(b) is a graph showing a relation between the time and the emission intensity.

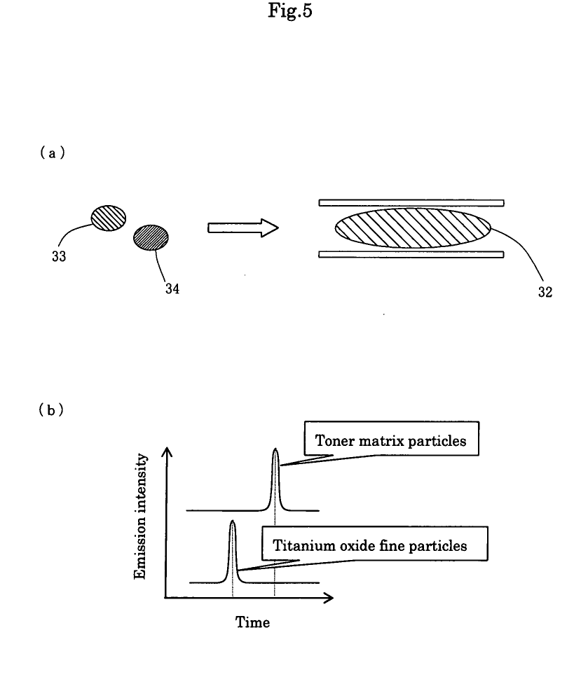

### DESCRIPTION OF REFERENCE NUMERALS

11 . . . A-Si photoconductor drum
12 . . . Scorotron charger
13 . . . Exposure device
14 . . . Processor
15 . . . Transfer roll
16 . . . Cleaning blade
17 . . . Destaticizing lamp
18 . . . Surface protection layer
19 . . . Photosensitive layer
20 . . . Carrier obstruction layer
21 . . . Conductive substrate
31 . . . Toner particles adhering titanium oxide fine particles to toner matrix particles
32 . . . Plasma
33 . . . Toner matrix particles
34 . . . Titanium oxide fine particles

1. A magnetic one-component toner for development of an electrostatic latent image used in a magnetic one-component jumping development system, in which electrostatic latent images formed on a latent image support are developed by a developer carrier, using an amorphous silicone photoconductor having a thickness of 10 to 30 μm as the latent image support and using a cleaning blade as a cleaning means for removing the toner from the surface of the photoconductor, wherein an inorganic metal oxide having a volume resistivity value within a range from 10⁰ to 10⁷Ω·cm, as an external additive, is added to the toner.

2. The magnetic one-component toner for development of an electrostatic latent image according to claim 1, wherein the inorganic metal oxide is added in an amount within a range from 0.5 to 5.0% by mass based on the toner.

3. The magnetic one-component toner for development of an electrostatic latent image according to claim 1, wherein the inorganic metal oxide is titanium oxide and a liberation rate of the titanium oxide is within a range from 10 to 22%.

4. The magnetic one-component toner for development of an electrostatic latent image according to claim 1, wherein the inorganic metal oxide is a low resistance titanium oxide having a volume resistivity value within a range from 10⁰ to 10⁷Ω·cm and the magnetic one-component toner further contains, as an external additive, a high resistance titanium oxide having a volume resistivity value within a range from 10⁸ to 10¹³Ω·cm, and also a mass ratio of both titanium oxides is, the low resistance titanium oxide:the high resistance titanium oxide=1.3:1 to 4:1.

5. The magnetic one-component toner for development of an electrostatic latent image according to claim 4, wherein the total amount of the low resistance titanium oxide and the high resistance titanium oxide is within a range from 0.5 to 5.0% by mass based on the toner.

6. The magnetic one-component toner for development of an electrostatic latent image according to claim 5, wherein a ratio of a volume resistivity value between the high resistance titanium oxide and the low resistance titanium oxide (volume resistivity value of the high resistance titanium oxide/volume resistivity value of the low resistance titanium oxide) is 10² or more.

7. The magnetic one-component toner for development of an electrostatic latent image according to claim 1, wherein a ten-point average roughness Rz of the surface of the sleeve of the developer carrier is from 2.0 to 6.0 μm.

8. An image forming method used in a magnetic one-component jumping development system, in which electrostatic latent images formed on a latent image support are developed by a developer carrier, using an amorphous silicone photoconductor having a thickness of 10 to 30 μm as the latent image support and using a cleaning blade as a cleaning means for removing the toner from the surface of the photoconductor, wherein an inorganic metal oxide having a volume resistivity value within a range from 10⁰ to 10⁷Ω·cm, as an external additive, is added to the toner.

9. The image forming method according to claim 8, wherein the inorganic metal oxide is added in an amount within a range from 0.5 to 5.0% by mass based on the toner.

10. The image forming method according to claim 9, wherein the inorganic metal oxide is titanium oxide and a liberation rate of the titanium oxide is within a range from 10 to 22%.

11. The image forming method according to claim 8, wherein the inorganic metal oxide is a low resistance titanium oxide having a volume resistivity value within a range from 10⁰ to 10⁷Ω·cm and the magnetic one-component toner further contains, as an external additive, a high resistance titanium oxide having a volume resistivity value within a range from 10⁸ to 10¹³Ω·cm, and also a mass ratio of both titanium oxides is, the low resistance titanium oxide:the high resistance titanium oxide=1.3:1 to 4:1.

12. The image forming method according to claim 8, wherein the total amount of the low resistance titanium oxide and the high resistance titanium oxide is within a range from 0.5 to 5.0% by mass based on the toner.

13. The image forming method according to claim 12, wherein a ratio of a volume resistivity value between the high resistance titanium oxide and the low resistance titanium oxide (volume resistivity value of the high resistance titanium oxide/volume resistivity value of the low resistance titanium oxide) is 10² or more.

14. The image forming method according to claim 8, wherein a ten-point average roughness Rz of the surface of the sleeve of the developer carrier is from 2.0 to 6.0 μm.
